(19) United States
(12) Patent Application Publication
(10) Pub. No.: US 2006/0059994 A1
(43) Pub. Date: Mar. 23, 2006

(54) Carrier to port mechanical interface for a pressure sensor

(75) Inventors: William C. Cameron, Grover, NC (US); Tyrone L. Cathcart, Lake Wylie, SC (US)

Correspondence Address: Kris T. Fredrick;Honeywell International, Inc., 101Columbia Rd., P.O. Box 2245, Morristown, NJ, 07962, US

(73) Assignee: Honeywell International, Inc.

(21) Appl. No.: 10/947,001

(22) Filed: Sep. 21, 2004

(51) Int. Cl. G01L 7/00; G08B 23/00; G08B 21/00

(52) U.S. Cl. 73/700; 340/693.5; 340/540

(57) ABSTRACT

A sensor system includes one or more sensor die, wherein each sensor die is located above a carrier having a carrier portion, such that the carrier is located above a port configured to include a media passage through which media (e.g., gas, liquid, and the like) can flow. The sensor system further includes a housing in which the sensor die, the carrier and the port are disposed, and a lid, which engages the housing and encloses the carrier and the port. An EMI shield generally surrounds the carrier, wherein such that the carrier portion of the carrier serves as an interface between the port and the in order to isolate the carrier from stresses in the port. The EMI shield can be attached to a Printed Circuit Board (PCB) to minimize electrical interferences for the components on the PCB and also to protect wire bonds thereof during handling. By implementing such a sensor system, the sensor die can be isolated from stresses in the housing. The carrier can also be isolated from stresses in the port due to the structure of the carrier, particularly the carrier portions.

### TECHNICAL FIELD

Embodiments are generally related to sensor methods and systems. Embodiments are also related to pressure sensors, thermal sensors and temperatures sensors.

### BACKGROUND OF THE INVENTION

Various sensors are known in the pressure sensing arts. Pressure sensors are deployed wherever the need for monitoring pressure is necessary. One example where pressure sensors are often utilized is in tire pressure sensing applications. Many different techniques have been proposed for sensing the pressure in tires and for delivering this information to the operator at a central location on the vehicle so that he knows that a tire is at low or high air pressure.

Such pressure sensors generally communicate with the vehicle so that the sensed pressure is displayed to the operator when the vehicle is moving, i.e. the wheel rotating relative to the body of the vehicle. Such devices are generally relatively complex and expensive or alternatively are not particularly robust.

Some tire pressure sensor systems incorporate a sensor that is fixed to the body so no rotating electrical contact between the rotating wheel and the chassis is required. In this system, a sensor rod is deflected by contact with the tire sidewall when the sidewall of the tire is deformed as occurs when the tire pressure is low. This system provides an indication of low tire pressure but is not robust. For example mud or other debris on the wheels may cause faulty readings. Furthermore, this system provides an indication only when the tire pressure is reduced significantly as is necessary for significant tire bulge to occur. Clearly such a system simply cannot provide a reading of actual tire pressure.

In another form of a fixed sensor, the height of the vehicle can be detected and when the height is reduced, it is deemed tire pressure is low. However, if the tire in a rut or is parked on uneven ground, a faulty low-pressure reading is likely to be generated.

More complicated systems are capable of monitoring tire pressure. For example, some pressure sensor systems utilize a rotating encoder formed by a multi-polar ring of magnetic segments of different polarity that are distributed circumferentially in a regular and alternating manner. A transmitter coil coaxial with the ring and a fixed pickup (an induction coil system) is energized by alternating electrical current flowing through the transmitter coil to generate a magnetic field superimposed on the magnetic field created by the multi-polar ring generates a signal picked up and delivers a signal relating the rotating characteristic of the wheel and thus, the state of the tire.

One of the problems with pressure sensors is that differences between the coefficients of thermal expansion of the sensor housing and the circuit board associated with the actual pressure sensing elements can cause a shift in output over temperature changes. Additionally, if the bond thicknesses differ between ports, the pressure sensor components can experience a temperature drift. A need thus exists for a system, including sensor components thereof, which prevents such a shift in output over temperature changes, along with temperature drifts.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved sensor methods and systems.

It is another aspect of the present invention to provide for improved pressure sensor methods and systems.

It is a further aspect of the present invention to provide protection for sensor die utilized in pressure sensing systems.

The aforementioned aspects of the invention and other objectives and advantages can now be achieved as described herein. A sensor system includes one or more sensor die, wherein each sensor die is located above a carrier having a carrier portion, such that the carrier is located above a port configured to include a media passage through which media (e.g., gas, liquid, and the like) can flow. The sensor system further includes a housing in which the sensor die, the carrier and the port are disposed, and a lid, which engages the housing and encloses the carrier and the port. An EMI shield generally surrounds the carrier, wherein such that the carrier portion of the carrier serves as an interface between the port and the in order to isolate the carrier from stresses in the port.

Such a system can further include a printed circuit board (PCB) to which the carrier is attached. The EMI shield is generally attached to the PCB to minimize electrical interference for the components on the PCB and to protect the wirebonds during handling. The PCB can be configured to include a gap within which the sensor die is disposed above and adjacent to the carrier. By implementing such a sensor system, the sensor die can be isolated from stresses in the housing. The carrier can also be isolated from stresses in the port due to the structure of the carrier, particularly the carrier portions.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of a sensor system, which can be implemented in accordance with a preferred embodiment of the present invention;

FIG. 2 illustrates a top view of the printed circuit board and sensor die depicted in FIG. 1, in accordance with a preferred embodiment of the present invention;

FIG. 3 illustrates a top view of the printed circuit board, sensor die and protruding portions of the carriers depicted in FIG. 1, in accordance with a preferred embodiment of the present invention; and

FIG. 4 illustrates a top perspective view of the sensor system depicted in FIG. 1, in accordance with a preferred embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

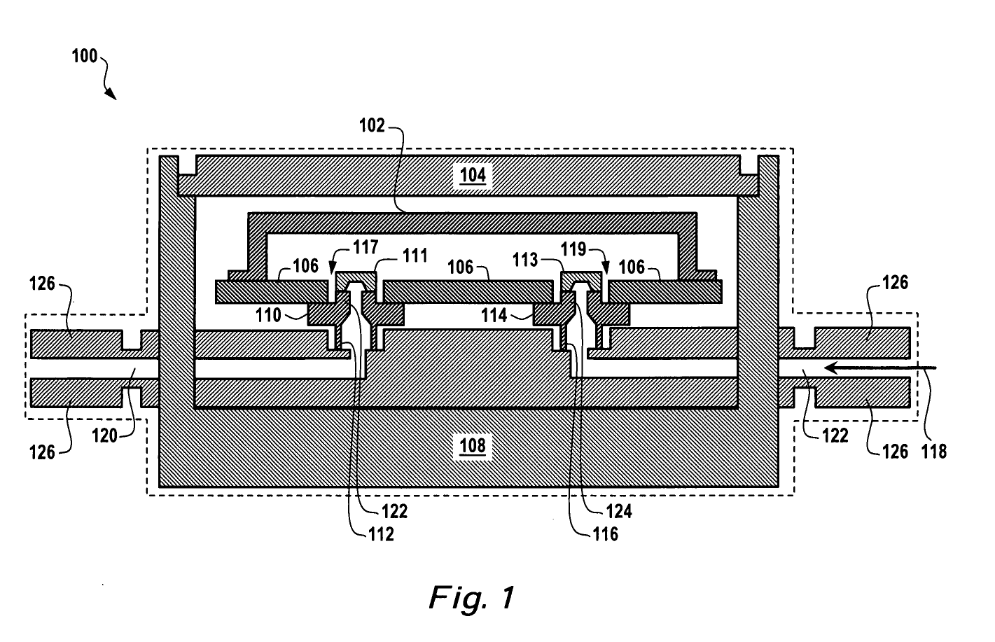

FIG. 1 illustrates a block diagram of a pressure sensor system 100, which can be implemented in accordance with one embodiment of the present invention. System 100 generally includes a housing 108 upon which a lid 104 can be located. Housing 108 surrounds a printed circuit board (PCB) 106, which can be connected to an EMI shield 102. Note that the EMI shield 102 is generally attached to the PCB 106 to minimize electrical interference for the components on the PCB 106 and to protect wirebonds thereof during handling.

A port 126 can be configured to include a media passage 120 and a media passage 122 through which a media of liquid, gas and/or fluid can flow, as indicated by arrow 118. An example of such a media is hydrogen gas. System 100 also includes sensor die 111 and 113, which can be configured from silicon and function as interdigital transducers for sensing pressure associated with a gas, liquid, and/or fluid. Sensor die 111 and 113, for example, can be implemented as surface acoustic wave (SAW) sensor components.

System 100 further includes a carrier 110 and a carrier 114. A carrier portion 112 can be integrated with carrier 110. Similarly, a carrier portion 116 can be integrated with carrier 114. Sensor die 111 and 113 are respectively located above and adjacent to carriers 110 and 114. Carrier 110 additionally includes a protruding portion 126 upon which sensor die 11 can rest. Additionally, carrier 113 includes a protruding portion 124 upon which carrier 112 can rest. A critical interface is thus formed between carriers 110, 114 and port 826. Such an interface is designed to isolate sensor die 111, 113 from stresses in port 826. Sensor die 111, 113 are respectively disposed within a gap 117 and a gap 119 formed in PCB 106. Respective carrier portions 112 and 116 of carriers 110 and 114 assist in isolating sensor die 111, 113 from stresses within port 126. For example, media passing through media passages 120 or 122 may cause thermal or pressure stresses to occur within the structure of port 126.

It is therefore important to isolate sensor die 111, 112 from stresses in port 126, particularly during pressure sensing operations involving measuring the pressure of media passing through media passage 120 and/or 122. The key characteristics of such an interface are the mechanical features of carriers 110, 114 and port 126, as well as an adhesive sealant, which can be utilized to the bond joint. The bond joint can be utilized to provide a uniform compliant bond. In this manner, electronic components can be isolated from sensing media by the bond joints and the sensor die 111 and 113. Note that sensor die 111 and 113 can be formed from silicon.

It is often the case that differences between the coefficients of thermal expansion of housing 108 and circuit boards encased within housing 908 can cause a shift in the output over temperature changes. Additionally, if bond thicknesses are different between ports, the parts thereof can experience a temperature drift. In order to prevent these undesirable features, the sensor die 111 and 113 are isolated from stresses in housing 108. Conventional designs transmit the stress from housing to the die as parts thereof experience thermal expansion. In the configuration depicted in FIG. 1, however, by setting the bond thickness in accordance with the design of carriers 110, 114, the difference between port-to-port bond thicknesses can be eliminated. Note that port 126 can be configured from stainless steel. The bond between carriers 110, 113 and stainless steel 126 can be verified to maintain a seal across an operating temperature range.

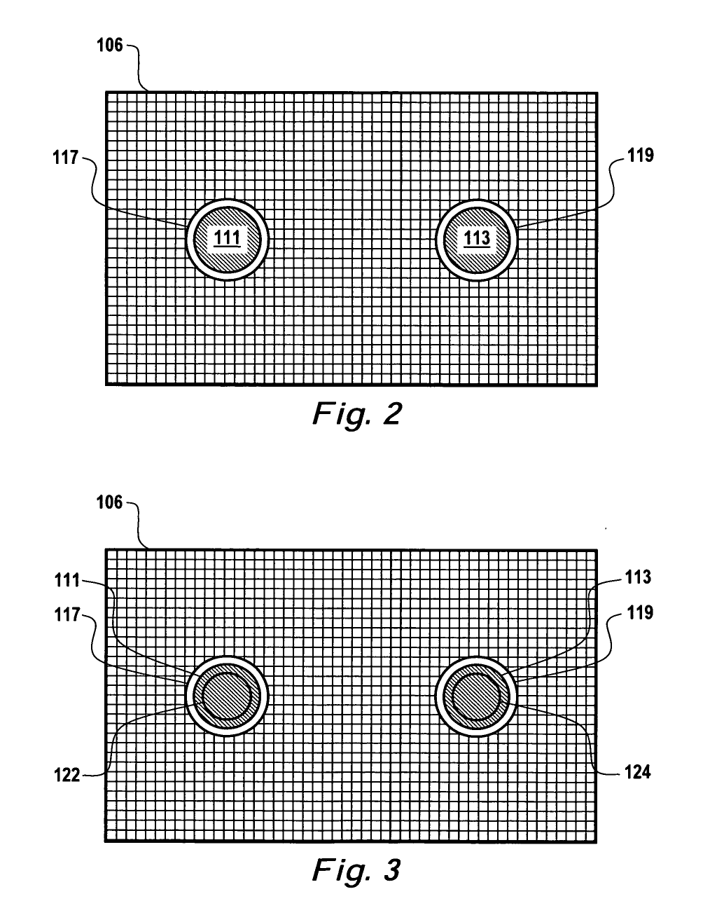

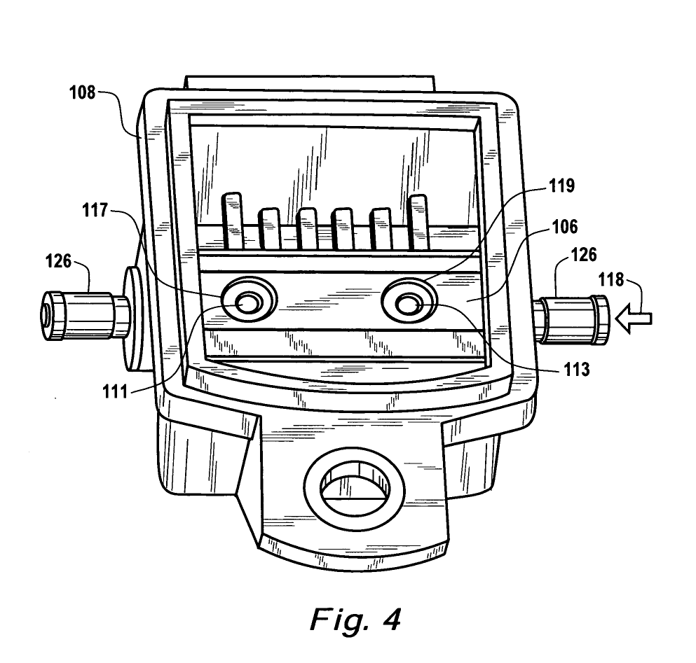

FIG. 2 illustrates a top view of the printed circuit board 106 and sensor die 111, 113 depicted in FIG. 1, in accordance with a preferred embodiment of the present invention. FIG. 3 illustrates a top view of the printed circuit board 106, sensor die 111, 113 and protruding portions 122, 124 of the carriers 110, 114 depicted in FIG. 1, in accordance with a preferred embodiment of the present invention. Note that in FIGS. 1-3, identical or similar parts are generally indicated by identical reference numerals. As depicted in FIGS. 1-3, a gap 117 and a gap 119 are formed within printed circuit board 106. Sensor die 111 and 113 can therefore be located within gaps 117 and 119.

FIG. 4 illustrates a top perspective view of the sensor system 100 depicted in FIG. 1, in accordance with a preferred embodiment of the present invention. Note that in FIGS. 1-4, identical or similar parts are generally indicated by identical reference numerals. The view shown in FIG. 4 thus depicts system 100 without the presence of lid 104. In FIG. 4, housing 108 is disclosed, including port 126 and gaps 117, 119, which are formed within printed circuit board 106. Sensor die 111, 113 can thus be respectively located within gaps 117 and 118.

Based on the foregoing, it can be appreciated that a sensor system is disclosed, which includes one or more sensor die, wherein each sensor die is located above a carrier having a carrier portion, such that the carrier is located above a port configured to include a media passage through which media (e.g., gas, liquid, and the like) can flow. The sensor system further includes a housing in which the sensor die, the carrier and the port are disposed, and a lid, which engages the housing and encloses the carrier and the port.

An EMI shield generally surrounds the carrier, wherein such that the carrier portion of the carrier serves as an interface between the port and the in order to isolate the carrier from stresses in the port. Additionally, such a system can include a printed circuit board (PCB) to which the carrier is attached. The EMI shield can be attached to the PCB to minimize electrical interferences for the components on the PCB and also to protect wire bonds thereof during handling. The PCB can be configured to include a gap within which the sensor die is disposed above and adjacent to the carrier. By implementing such a sensor system, the sensor die can be isolated from stresses in the housing. The carrier can also be isolated from stresses in the port due to the structure of the carrier, particularly the carrier portions.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A sensor system, comprising:
at least one sensor die located above at least one carrier having a carrier portion; and
a port configured to include a media passage through which media flows, wherein said carrier portion of said at least one carrier serves as an interface between said port and said at least one carrier in order to isolate said at least one sensor die from stresses in said port.

2. The system of claim 1 further comprising:
a housing in which said at least one sensor die, said at least one carrier and said port are disposed; and
a lid, which engages said housing and encloses said at least one carrier and said port.

3. The system of claim 1 further comprises an EMI shield that surrounds said at least one carrier.

4. The system of claim 3 further comprising a printed circuit board to which said at least one carrier is attached.

5. The system of claim 4 wherein said printed circuit board comprises at least one gap within which said sensor die is disposed above and adjacent to said at least one carrier

6. The system of claim 4 wherein said EMI shield is connected to said printed circuit board.

7. The system of claim 1 wherein said media comprises hydrogen gas.

8. A sensor system, comprising:
at least one sensor die located above at least one carrier having a carrier portion; and
a port configured to include a media passage through which media flows;
a housing in which said at least one sensor die, said at least one carrier and said port are disposed;
a lid, which engages said housing and encloses said at least one carrier and said port;
an EMI shield that surrounds said at least one carrier, wherein said carrier portion of said at least one carrier serves as interface between said port and said at least one carrier in order to isolate said at least one sensor die from stresses in said port.

9. The system of claim 8 further comprising a printed circuit board to which said at least one carrier is attached.

10. The system of claim 8 wherein said printed circuit board comprises at least one gap within which said sensor die is disposed above and adjacent to said at least one carrier.

11. The system of claim 8 wherein said at least sensor die comprises silicon.

12. The system of claim 8 wherein said media comprises hydrogen gas.
